(19) United States
(12) Patent Application Publication
(10) Pub. No.: US 2025/0370692 A1
(43) Pub. Date: Dec. 4, 2025

(54) DISPLAY METHOD AND DISPLAY SYSTEM

(71) Applicant: SEIKO EPSON CORPORATION, Tokyo (JP)

(72) Inventor: Yusei MOTEGI, SAPPORO-SHI (JP)

(21) Appl. No.: 19/220,312

(22) Filed: May 28, 2025

(30) Foreign Application Priority Data
May 29, 2024 (JP) 2024-087396

(51) Int. Cl. G06F 3/14; G06T 3/40

(52) U.S. Cl. CPC G06F 3/1423; G06T 3/40; G06F 3/1454

(57) ABSTRACT

A display method includes: acquiring, by a first display device, coordinate information; acquiring, by the first display device, first content corresponding to the coordinate information; acquiring, by the first display device, second content corresponding to the coordinate information; displaying, on a first display area, the first display area being an area in which a first image is displayed by the first display device, the first image generated based on a first aspect ratio of the first display area and the first content; and displaying, on a second display area, the second display area being an area in which a second image is displayed by a second display device, the second image generated based on a second aspect ratio of the second display area and the second content.

The present application is based on, and claims priority from JP Application Serial Number 2024-087396, filed May 29, 2024, the disclosure of which is hereby incorporated by reference herein in its entirety.

### BACKGROUND

### 1. Technical Field

The present disclosure relates to a display method and a display system.

### 2. Related Art

In the map search apparatus described in JP-A-2009-70228, a map or the like is displayed on a display device (see JP-A-2009-70228).

In the technique described in JP-A-2009-70228, a map database in which map data including a road map is stored is provided, and the map data has coordinate information.

Further, in the technique described in JP-A-2009-70228, taken image data is stored in a taken image database by being attached with coordinate information associated with coordinate information in a map database by matching processing based on lat/long information of an imaging point, and an image of a mark indicating an imaging point and an imaging direction is stored in an imaging point mark database by being attached with coordinate information associated with coordinate information in the map database.

Further, in the technique described in JP-A-2009-70228, a map based on map data which is read out and an imaging point mark are displayed on the display device.

Further, in the technique described in JP-A-2009-70228, by selecting any one of a plurality of imaging point marks displayed on the display device, a taken image based on taken image data corresponding to the imaging point mark thus selected is displayed on the display device.

Further, in the technique described in JP-A-2009-70228, the taken image is displayed on the display device in a state of being superimposed on the map, or in a state of being arranged side by side with the map.

As described above, in the technique described in JP-A-2009-70228, it is disclosed that when the map data and the taken image data associated with each other with the coordinate information are displayed on one display device, the taken image data is displayed so as to be superimposed on the map data, or the map data and the taken image data are displayed side by side.

JP-A-2009-70228 is an example of the related art.

However, in the technique described in JP-A-2009-70228, when the display is performed by a plurality of display devices is not sufficiently studied.

For example, it is assumed when the map data and the taken image data associated with each other with the coordinate information are displayed on a plurality of display devices each including a display area. In this case, when the technique described in JP-A-2009-70228 is applied, it results in that an image in which the taken image data is displayed to be superimposed on the map data or an image in which the map data and the taken image data are displayed side by side is displayed on each of the plurality of display devices, and thus, the display regions of the plurality of display devices cannot be effectively used.

### SUMMARY

In view of the problem described above, an aspect of the present disclosure is a display method including: acquiring, by a first display device, coordinate information; acquiring, by the first display device, first content corresponding to the coordinate information; acquiring, by the first display device, second content corresponding to the coordinate information; displaying, on a first display area, the first display area being an area in which a first image is displayed by the first display device, the first image generated based on a first aspect ratio of the first display area and the first content; and displaying, on a second display area, the second display area being an area in which a second image is displayed by a second display device, the second image generated based on a second aspect ratio of the second display area and the second content.

In view of the problem described above, an aspect of the present disclosure is a display system including: a first display device; and a second display device, wherein the first display device acquires coordinate information, acquires first content corresponding to the coordinate information, acquires second content corresponding to the coordinate information, and displays, on a first display area, the first display area being an area in which a first image is displayed by the first display device, the first image generated based on a first aspect ratio of the first display area and the first content, and the first display device or the second display device displays, on a second display area, the second display area being an area in which a second image is displayed by the second display device, the second image generated based on a second aspect ratio of the second display area and the second content.

### BRIEF DESCRIPTION OF THE DRAWINGS

FIG. 1 is a diagram showing a schematic configuration example of a display system according to an embodiment.

FIG. 2 is a diagram showing a schematic configuration example of a first display device according to the embodiment.

FIG. 3 is a diagram showing a schematic configuration example of a second display device according to the embodiment.

FIG. 4 is a diagram showing a schematic configuration example of a third display device according to the embodiment.

FIG. 5 is a diagram showing a schematic configuration example of a server device according to the embodiment.

FIG. 6A is a diagram showing an example of information of A-th content stored in the server device according to the embodiment.

FIG. 6B is a diagram showing an example of information of B-th content stored in the server device according to the embodiment.

FIG. 7A is a diagram showing a configuration example of a first master layer in the first display device according to the embodiment.

FIG. 7B is a diagram showing a configuration example of a second master layer in the first display device according to the embodiment.

FIG. 8A is a diagram showing an example of a first image displayed on a first display area of the first display device according to the embodiment.

FIG. 8B is a diagram showing an example of a second image displayed on a second display area of the second display device according to the embodiment.

FIG. 9A is a diagram showing an example of a 1a-th image displayed on the first display area of the first display device according to the embodiment.

FIG. 9B is a diagram showing an example of a 2a-th image displayed on the second display area of the second display device according to the embodiment.

FIG. 10 is a diagram showing an example of a procedure of processing performed in image display on the first display device according to the embodiment.

FIG. 11A is a diagram showing an example of a 1b-th image displayed on the first display area of the first display device according to the embodiment.

FIG. 11B is a diagram showing an example of a 2b-th image displayed on the second display area of the second display device according to the embodiment.

### DESCRIPTION OF EMBODIMENTS

An embodiment will hereinafter be described with reference to the drawings.

Note that in the following description, dimensions of regions and so on illustrated in the drawings are exemplifications for the description, and are not necessarily exact dimensions, and are not necessarily limited to illustrated dimensions.

In addition, in the drawings, when two or more line segments overlapping each other are illustrated, these line segments may be illustrated so as to slightly be shifted from each other in some cases in order to make these line segments eye-friendly.

In addition, in the following description, a number, an alphabet, or a combination thereof may be added to a name of an element such as first or second in some cases, but this is for convenience of description and is not intended to unnecessarily limit disclosure content.

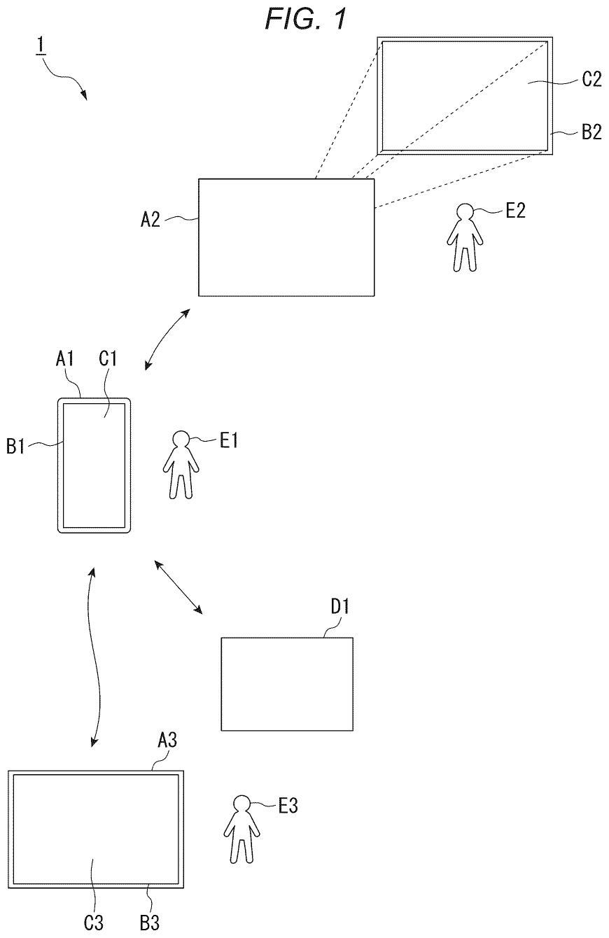

FIG. 1 is a diagram illustrating a schematic configuration example of a display system 1 according to the embodiment.

The display system 1 includes a first display device A1, a second display device A2, a third display device A3, and a server device D1.

FIG. 1 illustrates a first user E1 who operates the first display device A1, a second user E2 who operates the second display device A2, and a third user E3 who operates the third display device A3.

Here, in the present embodiment, the server device D1 is described as being provided to the display system 1, but as another example, the server device D1 may be regarded as a device outside the display system 1.

Further, in the present embodiment, when the display system 1 includes three display devices is illustrated, but as another example, a display system having two display devices may be implemented, or a display system having four or more display devices may be implemented.

In the present embodiment, the first display device A1 and the server device D1 communicate with each other by wire, wirelessly, or both.

Further, in the present embodiment, the first display device A1 and the second display device A2 communicate with each other by wire, wirelessly, or both.

Further, in the embodiment, the first display device A1 and the third display device A3 communicate with each other by wire, wirelessly, or both.

In the present embodiment, as a specific example, the first display device A1 is a smartphone, the second display device A2 is a projector, and the third display device A3 is a tablet terminal.

In the present embodiment, the display system 1 including the first display device A1 to the third display device A3 is described in order to explain a combination of the first display device A1, which is the smartphone as an example of a mobile terminal, and the second display device A2, which is the projector, and a combination of the first display device A1, which is the smartphone, and the third display device A3, which is the tablet terminal.

As another example, by separating the display system 1 into the combinations, a display system including the first display device A1 as the smartphone and the second display device A2 as the projector may be implemented, or a display system including the first display device A1 as a smartphone and the third display device A3 as a tablet terminal may be implemented.

In the present embodiment, there is described when the display devices are operated by the respective users, but as another example, two of the first user E1 to the third user E3 may be the same person, or all of the three users may be the same person.

Further, for example, one or more display devices may automatically execute processing according to a predetermined processing procedure without being operated by the user.

The first display device A1 includes a first display area B1. In the example of FIG. 1, a first image C1 is displayed on the first display area B1.

The second display device A2 includes a second display area B2. In the example of FIG. 1, a second image C2 is displayed on the second display area B2. Here, in the present embodiment, the second display device A2 is a projector, the second display area B2 is a screen, and the second image C2 is an image projected on that screen.

The present disclosure may be applied to when an image projected on that screen is viewed by a plurality of people in, for example, a predetermined room.

The third display device A3 includes a third display area B3. In the example of FIG. 1, a third image C3 is displayed on the third display area B3.

In the present embodiment, an image displayed on a display area may be an image of any display content, and may be, for example, an image representing a map, a sentence, a figure, a still image, a moving image, or a combination of two or more thereof.

Note that instead of the image, the image may be referred to as a video.

Here, a specific example of each of the display devices is illustrative only, and various devices may be used as each of the display devices.

For example, a display device of a car navigation system or a display device of an electronic blackboard system may be used as the second display device A2 or the third display device A3.

For example, as the second display device A2 or the third display device A3, a display device having a screen and having a function of displaying an image input from the outside on the screen may be used.

With respect to the first display area B1 of the first display device A1, the second display area B2 of the second display device A2 and the third display area B3 of the third display device A3 may be regarded as external monitors capable of screen sharing. Alternatively, the first display device A1 may be a projector and the second display device A2 may be a smartphone. In this case, it is preferable that the projector has an interactive function.

In the present embodiment, for the sake of convenience of explanation, when images different in content are displayed in synchronization between a sharing source and a sharing destination will also be referred to as screen sharing.

Further, the display device may be referred to as, for example, an information processing device.

The server device D1 may be, for example, a cloud device.

In the present embodiment, the first display device A1 communicates with the server device D1, but as another example, the second display device A2 or the third display device A3, or two or more display devices may communicate with the server device D1.

In the present embodiment, there is described when the first display device A1 is used as a device of the sharing source, and the second display device A2 or the third display device A3 is used as a device of the sharing destination in screen sharing.

Schematically, the first display device A1, which is the device of the sharing source, acquires image information from the server device D1 and displays an image based on the image information on the own screen of the first display device A1. Further, the first display device A1 transmits the image based on the image information to the device of the sharing destination as necessary. The second display device A2 or the third display device A3, which is the device of the sharing destination, displays that image on the own screen of the second display device A2 or the third display device A3.

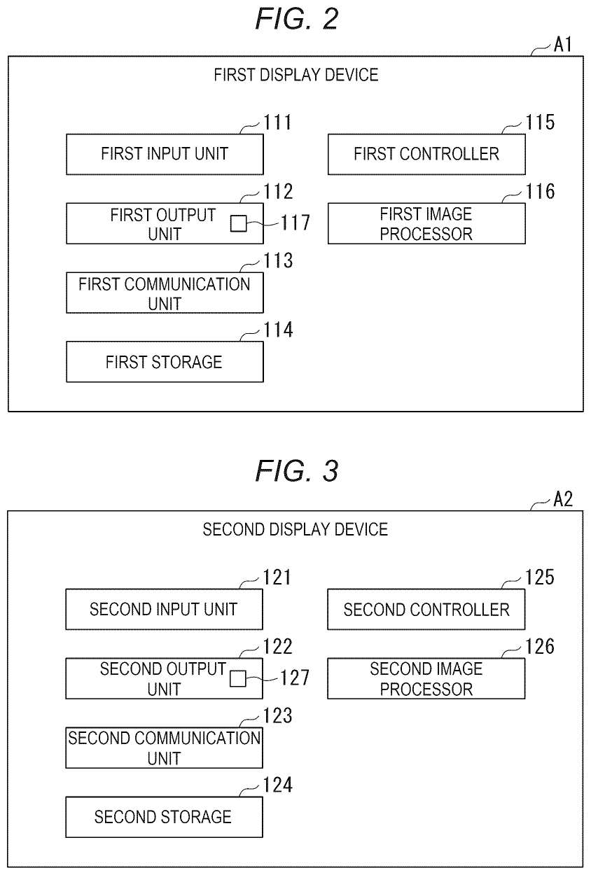

FIG. 2 is a diagram showing a schematic configuration example of the first display device A1 according to the embodiment.

The first display device A1 includes a first input unit 111, a first output unit 112, a first communication unit 113, a first storage 114, a first controller 115, and a first image processor 116.

The first output unit 112 includes a first display 117.

The first input unit 111 inputs information corresponding to an operation performed by the first user E1.

Further, the first input unit 111 may input, for example, information output from an external device coupled using a coupling terminal.

The first output unit 112 displays and outputs information on the first display area B1 with the first display 117. Note that the first output unit 112 may output a sound together with the display of the image.

Further, for example, the first output unit 112 may output information to an external device coupled using a coupling terminal.

Here, the first input unit 111 and the first display 117 may be implemented using, for example, a touch panel.

The first communication unit 113 communicates with an external device. In the present embodiment, the external device is the second display device A2, the third display device A3, or the server device D1.

The first storage 114 stores various types of information.

The first controller 115 performs various types of processing and control in the first display device A1.

In the present embodiment, the first display device A1 is implemented using a computer. The first controller 115 includes a processor such as a central processing unit (CPU) and performs various types of processing and control by the processor executing a predetermined program.

The first image processor 116 performs various types of image processing. In the present embodiment, for example, the first image processor 116 is controlled by the first controller 115 to perform various types of image processing.

Here, for example, the first display 117 displays and outputs an image processed by the first image processor 116.

FIG. 3 is a diagram showing a schematic configuration example of the second display device A2 according to the embodiment.

The second display device A2 includes a second input unit 121, a second output unit 122, a second communication unit 123, a second storage 124, a second controller 125, and a second image processor 126.

The second output unit 122 includes a second display 127.

The second input unit 121 inputs information corresponding to an operation performed by the second user E2. Here, the second input unit 121 may be implemented using, for example, a key or a touch panel.

The second output unit 122 displays and outputs information on the second display area B2 with the second display 127. The second output unit 122 may output a sound together with the display of the image.

The second communication unit 123 communicates with an external device. In the present embodiment, the external device is the first display device A1.

The second storage 124 stores various types of information.

The second controller 125 performs various types of processing and control in the second display device A2.

In the present embodiment, the second display device A2 is configured including a controlling computer. The second controller 125 includes a processor such as a CPU, and performs various types of processing and control by the processor executing a predetermined program.

The second image processor 126 performs various types of image processing.

Here, in the present embodiment, the second display device A2 is a projector.

The second image processor 126 includes, for example, a predetermined optical system and processes an image to be projected on the screen.

For example, the second display 127 outputs the image processed by the second image processor 126 to be displayed on the screen.

Note that in the present embodiment, the second image processor 126 and the second display 127 are described in a distinguished manner for the sake of convenience of explanation, but for example, the second image processor 126 and the second display 127 may be integrated with each other.

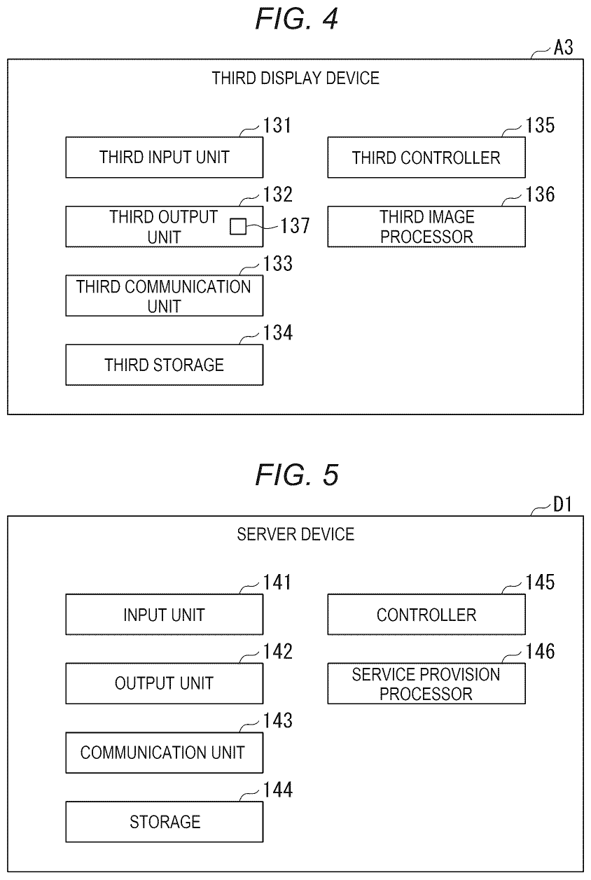

FIG. 4 is a diagram showing a schematic configuration example of the third display device A3 according to the embodiment.

The third display device A3 includes a third input unit 131, a third output unit 132, a third communication unit 133, a third storage 134, a third controller 135, and a third image processor 136.

The third output unit 132 includes a third display 137.

The third input unit 131 inputs information corresponding to an operation performed by the third user E3.

The third input unit 131 may input, for example, information output from an external device coupled using a coupling terminal.

The third output unit 132 displays and outputs information on the third display area B3 with the third display 137. Note that the third output unit 132 may output a sound together with the display of the image.

Further, for example, the third output unit 132 may output information to an external device coupled using a coupling terminal.

Here, the third input unit 131 and the third display 137 may be implemented using, for example, a touch panel.

The third communication unit 133 communicates with an external device. In the present embodiment, the external device is the first display device A1.

The third storage 134 stores various types of information.

The third controller 135 performs various types of processing and control in the third display device A3.

In the present embodiment, the third display device A3 is implemented using a computer. The third controller 135 includes a processor such as a CPU, and performs various types of processing and control by the processor executing a predetermined program.

The third image processor 136 performs various types of image processing. In the present embodiment, for example, the third image processor 136 is controlled by the third controller 135 to perform various types of image processing.

Here, the third display 137 displays and outputs, for example, the image processed by the third image processor 136.

FIG. 5 is a diagram showing a schematic configuration example of the server device D1 according to the embodiment.

The server device D1 includes an input unit 141, an output unit 142, a communication unit 143, a storage 144, a controller 145, and a service provision processor 146.

The input unit 141 inputs information corresponding to an operation performed by an operator (not shown).

The output unit 142 outputs information by display output, sound output, or the like.

The communication unit 143 communicates with an external device. In the present embodiment, the external device is the first display device A1.

The storage 144 stores various types of information.

The controller 145 performs various types of processing and control in the server device D1.

In the present embodiment, the server device D1 is implemented using a computer. The controller 145 includes a processor such as a CPU, and performs various types of processing and control by the processor executing a predetermined program.

The service provision processor 146 performs processing for providing a predetermined service. In the present embodiment, the service provision processor 146 is controlled by, for example, the controller 145 to perform various types of processing.

Here, in the present embodiment, when the service provision processor 146 of the server device D1 performs a service of providing predetermined information will be described.

The information is stored in, for example, the storage 144. As another example, the information may be stored in a database or the like (not shown) provided outside the server device D1, and in this case, the server device D1 acquires the information from that database or the like.

In the present embodiment, the information provided by the server device D1 is map information and aerial photograph information.

Note that the information provided by the server device D1 is not particularly limited, and any other information may be used.

Here, in the present embodiment, there is described when the server device D1 is operated by the operator, but, for example, the server device D1 may be remotely operated by the operator.

As another example, the server device D1 may automatically perform predetermined processing without being operated by the operator.

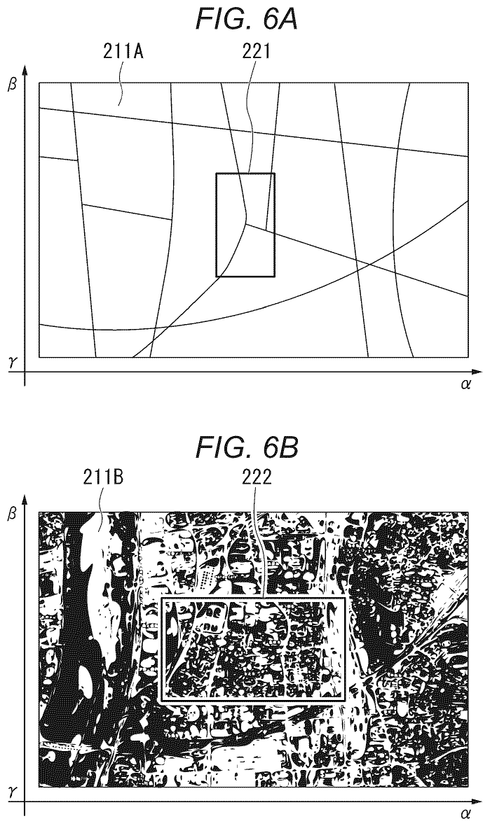

The map information and the aerial photograph information provided by the server device D1 will be described with reference to FIGS. 6A and 6B.

In the present embodiment, the first display device A1 performs processing of acquiring desired map information from the server device D1 and processing of acquiring desired aerial photograph information from the server device D1.

Note that, here, for the sake of convenience of explanation, acquisition processing of the map information and acquisition processing of the aerial photograph information will be described separately, but for example, the acquisition processing of these two types of information may be realized by common request information.

FIG. 6A is a diagram illustrating an example of information of A-th content 211A stored in the server device D1 according to the embodiment.

The information of the A-th content 211A is, for example, information of a map of a predetermined area. Note that, in the example of FIG. 6A, the outline of the map is schematically illustrated for the sake of explanation, and is not necessarily exact.

FIG. 6A shows an α-β orthogonal coordinate system, which is a two-dimensional orthogonal coordinate system, for the sake of convenience of explanation. In the α-β orthogonal coordinate system, an origin γ, an x axis, and a β axis are shown. Note that in the present embodiment, an α direction parallel to the α axis corresponds to a so-called horizontal direction, and a β direction parallel to the β axis corresponds to a so-called vertical direction.

FIG. 6A shows an example of a first provision range 221 set in the A-th content 211A.

The first provision range 221 represents a range of an information portion provided to a provision destination by the service provision processor 146 in the entire A-th content 211A.

In the present embodiment, the provision destination is the first display device A1.

In the present embodiment, the first display device A1 transmits request information to the server device D1 in a WEB site provided by the server device D1.

The service provision processor 146 of the server device D1 determines the first provision range 221 based on the request information received from the first display device A1.

Then, the service provision processor 146 of the server device D1 transmits the information portion contained in the first provision range 221 thus determined in the A-th content 211A to the first display device A1.

Here, the first display device A1 changes the request information as necessary and transmits the request information to the server device D1. By changing the request information from the first display device A1, the first provision range 221 in the server device D1 is changed, and the information transmitted from the server device D1 to the first display device A1 is changed.

FIG. 6B is a diagram illustrating an example of information of B-th content 211B stored in the server device D1 according to the embodiment.

The information of the B-th content 211B is, for example, information of an aerial photograph of a predetermined area. Note that, in the example of FIG. 6B, the outline of the aerial photograph is schematically shown for the sake of explanation, and is not necessarily exact.

FIG. 6B shows the α-β orthogonal coordinate system, which is a two-dimensional orthogonal coordinate system, for the sake of convenience of explanation.

Here, in the present embodiment, the same α-β orthogonal coordinate system is shown in FIGS. 6A and 6B for the sake of convenience of explanation, but as these coordinate systems, for example, separate coordinate systems may be used, or a commonalized coordinate system may be used. For example, different orthogonal coordinate systems a correspondence relationship of which is figured out may be used in FIG. 6A and FIG. 6B.

FIG. 6B shows an example of a second provision range 222 set in the B-th content 211B.

The second provision range 222 represents a range of an information portion provided to a provision destination by the service provision processor 146 in the entire B-th content 211B.

In the present embodiment, the provision destination is the first display device A1.

In the present embodiment, the first display device A1 transmits request information to the server device D1 in a WEB site provided by the server device D1.

The service provision processor 146 of the server device D1 determines the second provision range 222 based on the request information received from the first display device A1.

Then, the service provision processor 146 of the server device D1 transmits the information portion contained in the second provision range 222 thus determined in the B-th content 211B to the first display device A1.

Here, the first display device A1 changes the request information as necessary and transmits the request information to the server device D1. By changing the request information from the first display device A1, the second provision range 222 in the server device D1 is changed, and the information transmitted from the server device D1 to the first display device A1 is changed.

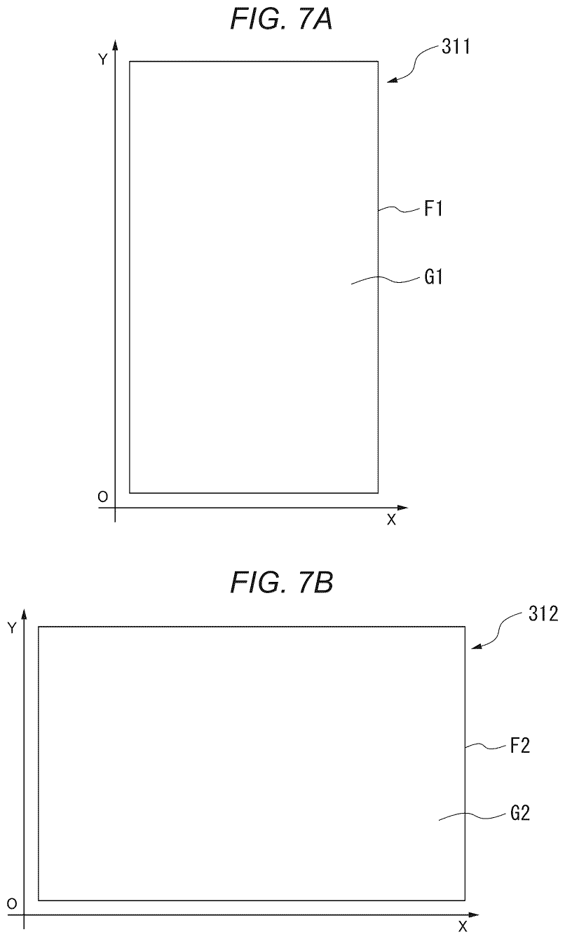

Screen sharing in a combination of the first display device A1 and the second display device A2 will be described with reference to FIGS. 7A, 7B, 8A, 8B, 9A, 9B, and 10. In the present embodiment, the first display device A1 is a master device, and the second display device A2 is a slave device.

Two master layers in the first display device A1 will be described with reference to FIGS. 7A and 7B.

In the present embodiment, the first display device A1 constructs a first master layer 311 for storing an image of the A-th content to be displayed in the own device of the sharing source, and a second master layer 312 for storing an image of the B-th content to be displayed in the sharing destination.

FIG. 7A is a diagram showing a configuration example of the first master layer 311 in the first display device A1 according to the embodiment.

FIG. 7A shows an X-Y orthogonal coordinate system, which is a two-dimensional orthogonal coordinate system, for the sake of convenience of explanation. In the X-Y orthogonal coordinate system, an origin O, an X axis, and a Y axis are shown.

Note that in the present embodiment, an X direction parallel to the X axis corresponds to a so-called horizontal direction, a positive side corresponds to a right side, and a negative side corresponds to a left side. Further, in the present embodiment, a Y direction parallel to the Y axis corresponds to a so-called vertical direction, a positive side corresponds to the upper side, and a negative side corresponds to the lower side. The horizontal direction and the vertical direction may be reversely figured out.

Here, in the present embodiment, the X direction and the Y direction in the X-Y orthogonal coordinate system are respectively parallel to the x direction and the β direction in the α-β orthogonal coordinate system shown in FIGS. 6A and 6B, but as another example, the X direction and the Y direction in the X-Y orthogonal coordinate system may be associated with the x direction and the β direction in the α-β orthogonal coordinate system shown in FIGS. 6A and 6B in another aspect.

In the first display device A1, the first image processor 116 draws a master image of the A-th content in the first master layer 311.

In the present embodiment, a region of the master image is referred to as a master region.

In the example of FIG. 7A, a first master image G1 is shown as the master image drawn in the first master layer 311.

Further, in the example of FIG. 7A, a first master region F1 is shown as the master region of the first master image G1.

Here, the first master layer 311 may be, for example, a predetermined region provided to a recording region of the first storage 114. In this case, processing of drawing the first master image G1 in the first master layer 311 may be processing of storing the data of the first master image G1 in the first master layer 311 to store the first master image G1.

Note that in this case, for example, the first master layer 311 and the first master region F1 may be regarded as substantially the same thing.

In the example of FIG. 7A, the first master region F1 is a rectangular region surrounded by two line segments in the X direction parallel to the X axis and two line segments in the Y direction parallel to the Y axis. Note that a square may be included as a kind of rectangle.

In the present example, the first image processor 116 of the first display device A1 transmits the request information of the A-th content to the server device D1 to thereby acquire the information portion of the first provision range 221 based on the request information from the server device D1. The information portion corresponds to the map information of the first provision range 221. Then, the first image processor 116 of the first display device A1 draws the map information thus acquired in the first master layer 311 as the first master image G1.

Here, in the present embodiment, the request information includes information representing a reference point and information representing an aspect ratio.

The reference point is a point serving as a reference for setting the first provision range 221 in the A-th content 211A in the server device D1, and may be, for example, a point at the center position of the first provision range 221 in the A-th content 211A.

The aspect ratio is used as a value for setting a frame of the first provision range 221 with reference to the reference point.

Such information representing the reference point may be regarded as coordinate information representing coordinates of the content. Further, such a combination of the reference point and the aspect ratio may also be regarded as the coordinate information representing the coordinates and the range of the content. That is, the request information may be regarded as information including the coordinate information of the content.

The service provision processor 146 of the server device D1 determines and sets the first provision range 221 suitable for the reference point and the aspect ratio designated by the request information of the A-th content from the first display device A1.

In the present example, when one or both of the reference point and the aspect ratio identified by the request information of the A-th content change, the first provision range 221 may change.

In the present embodiment, the first image processor 116 of the first display device A1 determines the aspect ratio to be contained in the request information of the A-th content based on the aspect ratio of the first display area B1 of the first display device A1. These aspect ratios may be, for example, the same.

In the first display device A1, for example, the aspect ratio of the first display area B1 is stored in advance in the first storage 114.

In the example of FIG. 7A, the first image processor 116 of the first display device A1 sets a first region H1 matching the aspect ratio of the first display area B1 of the first display device A1 in the first master region F1. Then, the first image processor 116 of the first display device A1 trims the image portion provided in the first region H1 and displays and outputs the image portion thus trimmed on the first display area B1. Here, the first region H1 is, for example, the same as the first master region F1, but may be different therefrom.

The trimming may be referred to as, for example, clipping.

Note that the first region H1 may be associated with the first master layer 311, the first master region F1, or the like using, for example, the coordinates in the X-Y orthogonal coordinate system.

FIG. 7B is a diagram showing a configuration example of the second master layer 312 in the first display device A1 according to the embodiment.

FIG. 7B shows an X-Y orthogonal coordinate system, which is a two-dimensional orthogonal coordinate system, for the sake of convenience of explanation.

Here, in the present embodiment, the same X-Y orthogonal coordinate system is shown in FIGS. 7A and 7B for the sake of convenience of explanation, but as these coordinate systems, for example, separate coordinate systems may be used, or a commonalized coordinate system may be used. For example, different orthogonal coordinate systems a correspondence relationship of which is figured out may be used in FIG. 7A and FIG. 7B.

In the first display device A1, the first image processor 116 draws the master image of the B-th content in the second master layer 312.

In the example of FIG. 7B, a second master image G2 is shown as the master image drawn in the second master layer 312.

Further, in the example of FIG. 7B, a second master region F2 is shown as the master region of the second master image G2.

Here, the second master layer 312 may be, for example, a predetermined region provided to a recording region of the first storage 114. In this case, processing of drawing the second master image G2 in the second master layer 312 may be processing of storing the data of the second master image G2 in the second master layer 312 to store the second master image G2.

Note that in this case, for example, the second master layer 312 and the second master region F2 may be regarded as substantially the same thing.

In the example of FIG. 7B, the second master region F2 is a rectangular region surrounded by two line segments in the X direction parallel to the X axis and two line segments in the Y direction parallel to the Y axis. Note that a square may be included as a kind of rectangle.

In the present example, the first image processor 116 of the first display device A1 transmits the request information of the B-th content to the server device D1 to of the second thereby acquire the information portion provision range 222 based on the request information from the server device D1. The information portion corresponds to aerial photograph information of the second provision range 222. Then, the first image processor 116 of the first display device A1 draws the aerial photograph information thus acquired in the second master layer 312 as the second master image G2.

Here, in the present embodiment, the request information includes information representing a reference point and information representing an aspect ratio.

The reference point is a point serving as a reference for setting the second provision range 222 in the B-th content 211B in the server device D1, and may be, for example, a point at the center position of the second provision range 222 in the B-th content 211B.

The aspect ratio is used as a value for setting a frame of the second provision range 222 with reference to the reference point.

The service provision processor 146 of the server device D1 determines and sets the second provision range 222 suitable for the reference point and the aspect ratio designated by the request information of the B-th content from the first display device A1.

In the present example, when one or both of the reference point and the aspect ratio identified by the request information of the B-th content change, the second provision range 222 may change.

In the present embodiment, the first image processor 116 of the first display device A1 determines the aspect ratio to be contained in the request information of the B-th content based on the aspect ratio of the second display area B2 of the second display device A2. These aspect ratios may be, for example, the same.

In the present embodiment, in the first display device A1, for example, the aspect ratio of the second display area B2 of the second display device A2 may be stored in advance in the first storage 114, or information identifying the aspect ratio of the second display area B2 of the second display device A2 may be acquired from the second display device A2 or another device. The other device may be the server device D1.

In the first display device A1, for example, the aspect ratio of the second display area B2 of the second display device A2 may be acquired from the second display device A2 or another device in real time when sharing the screen or the like.

In the example of FIG. 7B, the first image processor 116 of the first display device A1 sets a second region H2 which matches the aspect ratio of the second display area B2 of the second display device A2 in the second master region F2. Then, the first image processor 116 of the first display device A1 trims the image portion provided in the second region H2 and transmits the image portion thus trimmed to the second display device A2. Accordingly, the second image processor 126 of the second display device A2 displays and outputs that image portion on the second display area B2. Here, the second region H2 is, for example, the same as the second master region F2, but may be different therefrom.

Note that the second region H2 may be associated with the second master layer 312, the second master region F2, or the like using, for example, the coordinates in the X-Y orthogonal coordinate system.

In the present embodiment, the aspect ratio of the first display area B1 of the first display device A1 is (16:9) in (Y direction:X direction), and is (1920:1080) in resolution.

Further, in the present embodiment, the aspect ratio of the second display area B2 of the second display device A2 is (9:16) in (Y direction:X direction), and is (1080:1920) in resolution.

As described above, the aspect ratio of the first display area B1 is different from the aspect ratio of the second display area B2.

Here, in the first display device A1, the first master image G1 of the A-th content and the second master image G2 of the B-th content are associated with each other using coordinates.

The first region H1 and the second region H2 may be associated with each other using, for example, the coordinates in the X-Y orthogonal coordinate system, or may be associated with each other using a relative positional relationship.

In the present embodiment, the map information as the A-th content and the aerial photograph information as the B-th content represent information at the same position in the same coordinate values, but as another example, the A-th content and the B-th content may each be any content.

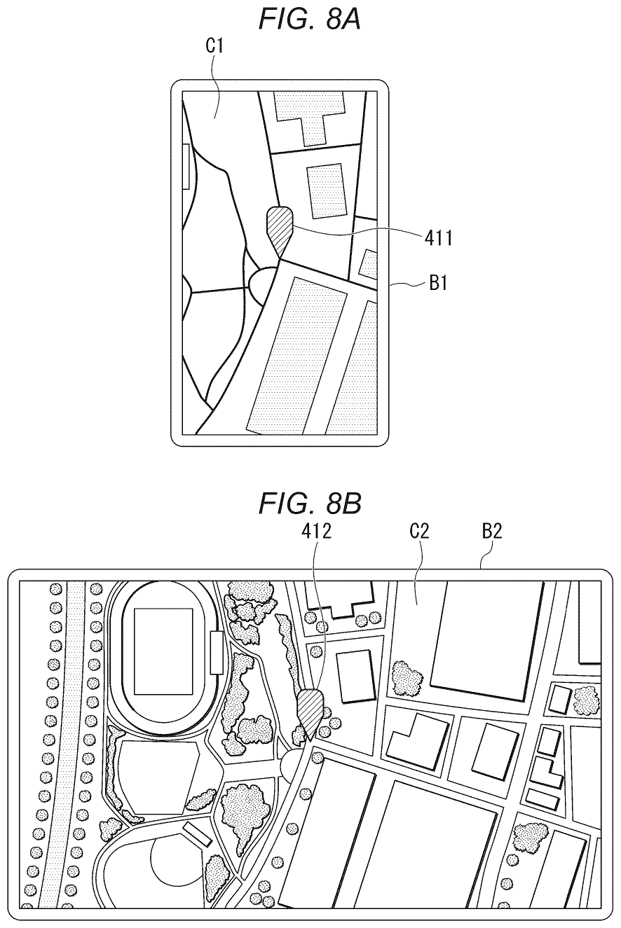

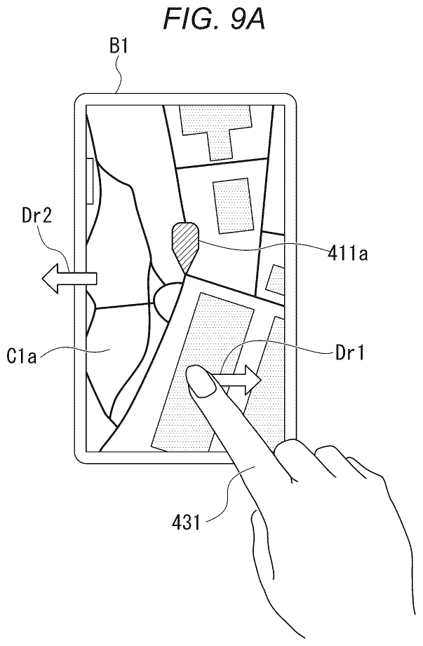

FIG. 8A is a diagram showing an example of the first image C1 displayed on the first display area B1 of the first display device A1 according to the embodiment.

In the example of FIG. 8A, a first icon 411 is displayed so as to overlap the first image C1.

The first icon 411 may be displayed, for example, at the center of the first display area B1 or may be displayed at another position.

FIG. 8B is a diagram showing an example of the second image C2 displayed on the second display area B2 of the second display device A2 according to the embodiment.

In the example of FIG. 8B, a second icon 412 is displayed so as to overlap the second image C2.

For example, the second icon 412 may indicate, on the aerial photograph, the same position as the position indicated by the first icon 411 on the map.

Note that the first icon 411 may be displayed at the center position of the first display area B1, and the second icon 412 may be displayed at the center position of the second display area B2.

Here, in the present example, the first image C1 and the second image C2 are synchronized with each other based on coordinates. As the coordinates, for example, latitude and longitude may be used.

Further, in the present example, when the display content of the first image C1 displayed on the first display area B1 of the first display device A1 changes, the first image processor 116 of the first display device A1 performs image processing so that the display content of the second image C2 displayed on the second display area B2 of the second display device A2 also changes so as to follow that change. Accordingly, the coordinates of the second image C2 also move following the movement of the coordinates of the first image C1.

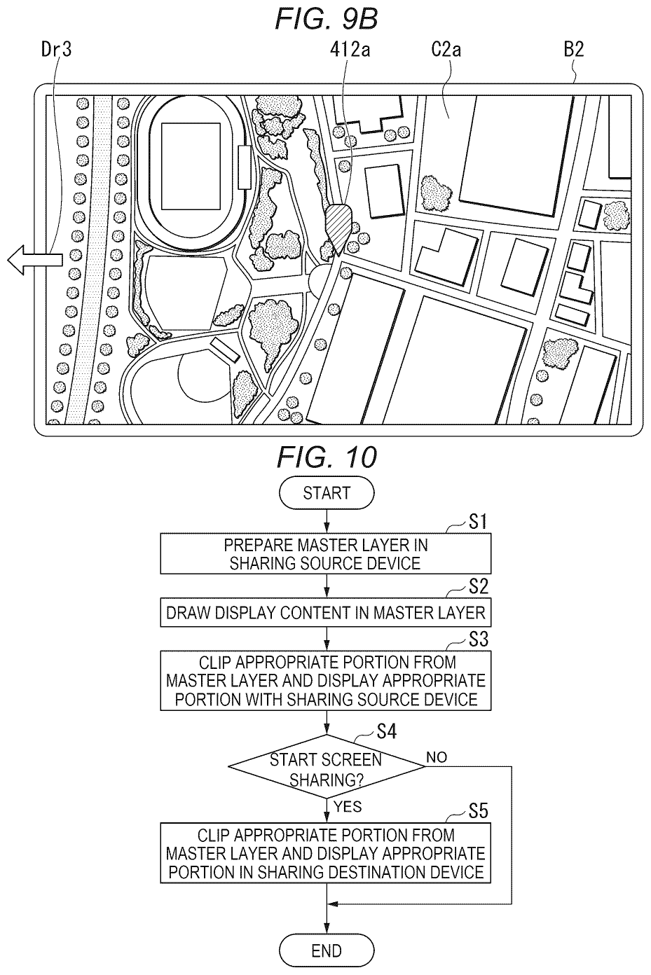

FIG. 9A is a diagram showing an example of a 1a-th image C1a displayed on the first display area B1 of the first display device A1 according to the embodiment.

In the example of FIG. 9A, a 1a-th icon 411a is displayed so as to overlap the 1a-th image C1a.

Note that the 1a-th icon 411a is an icon similar to the first icon 411.

FIG. 9B is a diagram showing an example of a 2a-th image C2a displayed on the second display area B2 of the second display device A2 according to the embodiment.

In the example of FIG. 9B, a 2a-th icon 412a is displayed so as to overlap the 2a-th image C2a.

Note that the 2a-th icon 412a is an icon similar to the second icon 412.

FIG. 9A illustrates a state in which the first display area B1 of the first display device A1 is swiped in a first direction Dr1 by a finger 431 of the first user E1. In the present example, when the first display area B1 is a touch panel is shown, but the operation in the first direction Dr1 may be performed by an operation of a button, a key, or the like instead of the swipe.

In the example of FIG. 9A, the 1a-th image C1a, which is an image in which the first image C1 illustrated in FIG. 8A is about to be moved in the second direction Dr2 by the coordinates corresponding to the swipe, is displayed. Note that in the example of FIG. 9A, the illustration is simplified and an image similar to the first image C1 is shown as the 1a-th image C1a, but actually, the content displayed is gradually shifted by the swipe.

Here, the second direction Dr2 is a direction opposite to the first direction Dr1. In the example of FIG. 9A, the first direction Dr1 is the right direction, and the second direction Dr2 is the left direction. Note that instead of the left and right directions, the up and down directions, or oblique directions may be used.

In FIG. 9B, a 2a-th image C2a as an image in which the second image C2 illustrated in FIG. 8B is about to be moved in the third direction Dr3 by the same coordinates as the change amount of the first image C1, is displayed. Note that in the example of FIG. 9B, the illustration is simplified and an image similar to the second image C2 is shown as the 2a-th image C2a, but actually, the content displayed is gradually shifted by the swipe.

Here, the third direction Dr3 is the same direction as the second direction Dr2.

As described above, when the image displayed on the first display area B1 of the sharing source moves, the image displayed on the second display area B2 of the sharing destination also moves in synchronization with that movement.

Note that the finger 431, the arrow indicating the first direction Dr1, and the arrow indicating the second direction Dr2 illustrated in FIG. 9A are illustrated for the description, and are not displayed on the first display area B1.

In addition, an arrow indicating the third direction Dr3 illustrated in FIG. 9B is illustrated for the description, and is not displayed on the second display area B2.

For example, it is possible to network-stream the video from the first display device A1 to the second display device A2 to share that video.

The first display device A1 serving as a sharing source prepares the first master layer 311 which is a displaying layer for displaying video on its own display, and prepares the second master layer 312 which is an external displaying layer for sharing a screen in an external display.

Then, the first display device A1, which is the sharing source, draws different contents according to the respective master layers based on the same coordinate information respectively on the two master layers, and performs display control for the respective displays.

In the present example, it is possible to perform such display control as in the examples of FIGS. 8A, 8B, 9A, and 9B using an application using such a mechanism.

That application handles map information and aerial photograph information.

In that application, the display content of the A-th content is displayed and output on the display as the sharing source, and the display content of the B-th content is displayed and output on the sharing destination display. On this occasion, the application synchronizes these display contents based on, for example, coordinates of latitude and longitude.

Accordingly, for example, when a map is displayed in the device of the sharing source and an aerial photograph of an area corresponding to the map is displayed in the device of the sharing destination, and when coordinate movement is instructed by the first user E1 who views the map in the device of the sharing source, it is possible to realize display in which the coordinate movement of the aerial photograph in the device of the sharing destination is performed in synchronization with the coordinate movement of the map.

Although the coordinate movement with the swipe operation is exemplified in the present example, the screens of the sharing source and the sharing destination may be linked with respect to an image reduction with a pinch-in operation, an image enlargement with a pinch-out operation, an image rotation with a rotation operation, and so on, as another example.

Note that the content displayed on the device of the sharing source and the content displayed on the device of the sharing destination may be reversed.

Here, in the examples of FIGS. 8A, 8B, 9A, and 9B, there is shown an aspect in which when the display content on the first display area B1 of the first display device A1 is moved, and thus, the display content on the first display area B1 of the first display device A1 and the display content on the second display area B2 of the second display device A2 are moved in conjunction with each other, the first icon 411 displayed on the first display area B1 and the second icon 412 displayed on the second display area B2 remain at the center positions of the respective display areas.

As another example, in such a case, there may be used an aspect in which the first icon 411 displayed on the first display area B1 and the second icon 412 displayed on the second display area B2 move within the frames of the respective display areas in conjunction with each other.

Further, in the examples of FIGS. 8A, 8B, 9A, and 9B, there is indicated an aspect in which the icons are respectively displayed on the first display area B1 of the first display device A1 and the second display area B2 of the second display device A2.

As another example, an aspect in which an icon is displayed on only any one of the first display area B1 of the first display device A1 and the second display area B2 of the second display device A2 may be used.

Here, whether to display the icon may be determined in accordance with a device such as the first display area B1 of the first display device A1 or the second display area B2 of the second display device A2, or may be determined in accordance with the type of the content displayed such as the A-th content or the B-th content.

FIG. 10 is a diagram showing an example of a procedure of processing performed in image display in the first display device A1 according to the embodiment.

In the present example, the device of the sharing source is the first display device A1, and the device of the sharing destination is the second display device A2.

Further, in the present example, the screen sharing is switched on and off in the first display device A1. The switching may be performed by, for example, the first user E1 operating the first display device A1, or may be automatically performed in accordance with a predetermined switching condition.

In step S1, in the first display device A1 which is the device of the sharing source, the first image processor 116 prepares the first master layer 311 and the second master layer 312 as preparation of the master layer.

Then, in step S2, in the first display device A1, the first image processor 116 draws a display content in the master layer. In the present example, the first image processor 116 draws the first master image G1 of the A-th content in the first master layer 311, and draws the second master image G2 of the B-th content in the second master layer 312.

Then, in step S3, in the first display device A1, the first image processor 116 clips an appropriate portion from the first master layer 311 and displays an image of that portion on the first display area B1.

In the present example, the appropriate portion is a portion of the first region H1. Further, the appropriate portion is clipped by trimming.

Then, in step S4, in the first display device A1, the first image processor 116 determines whether to start screen sharing.

In the present example, the first image processor 116 determines to start the screen sharing when the screen sharing is already set to an ON state or when the screen sharing is switched from an OFF state to the ON state in real time. On the other hand, when the screen sharing is set to the OFF state, the first image processor 116 determines not to start the screen sharing.

In the determination in step S4, in the first display device A1, when the first image processor 116 determines to start the screen sharing, YES is determined in step S4, and the process proceeds to step S5.

On the other hand, in the determination of step S4, in the first display device A1, when the first image processor 116 determines not to start the screen sharing, NO is determined in step S4, and the processing of the present flow ends.

In step S5, in the first display device A1, the first image processor 116 performs processing for clipping the appropriate portion from the second master layer 312 and displaying an image of that portion on the second display area B2 of the second display device A2 which is the device of the sharing destination. Then, the processing of the present flow ends.

In the present example, the appropriate portion is a portion of the second region H2. Further, the appropriate portion is clipped by trimming.

As a specific example, when the first user E1 is viewing the first image C1 displayed on the first display area B1 of the first display device A1, it is possible for the second user E2 to view the second image C2 displayed on the second display area B2 of the second display device A2. For example, a size of the second display area B2 of the second display device A2 is larger than a size of the first display area B1 of the first display device A1, and a plurality of users can simultaneously view the second image C2.

For example, when the first user E1 operates the first display device A1 to give an instruction to shift the reference point of the first region H1, the request information related to the A-th content which is updated and in which the reference point is shifted is transmitted from the first display device A1 to the server device D1. Accordingly, the first provision range 221 in the server device D1 is updated, and the image portion transmitted from the server device D1 to the first display device A1 is updated. Then, the first master image G1 in the first display device A1 is updated, and the image content of the first image C1 is updated. Further, in conjunction with the update of the image content of the first image C1, request information related to the B-th content which is updated and in which the reference point is shifted is transmitted from the first display device A1 to the server device D1. Accordingly, the second provision range 222 in the server device D1 is updated, and the image portion transmitted from the server device D1 to the first display device A1 is updated. Then, the second master image G2 in the first display device A1 is updated, and the image content of the second image C2 is updated.

As an example, when the reference point of the map information displayed on the first display area B1 is shifted, the map information displayed on the first display area B1 is scrolled accordingly, and the aerial photograph information displayed on the second display area B2 is scrolled in synchronization therewith.

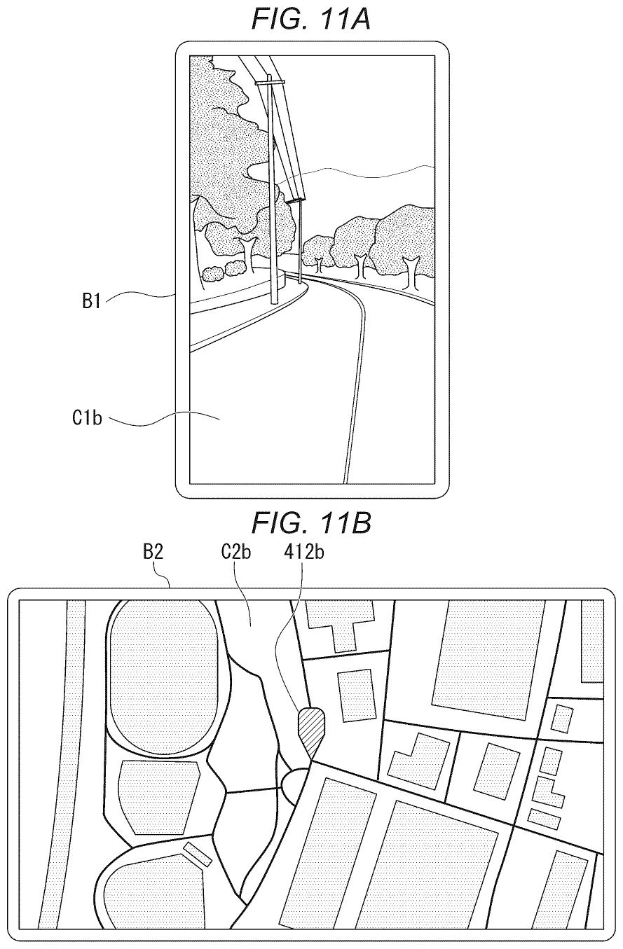

A display example of other content will be described with reference to FIGS. 11A and 11B.

FIG. 11A is a diagram illustrating an example of a 1b-th image C1b displayed on the first display area B1 of the first display device A1 according to the embodiment.

FIG. 11B is a diagram showing an example of a 2b-th image C2b displayed on the second display area B2 of the second display device A2 according to the embodiment.

In the present example, the A-th content displayed on the first display area B1 of the sharing source is content of information for displaying an image taken by an omnidirectional camera with reference to a designated position. With that content, the viewer can view the actual scenery existing around that position.

Note that the image taken by the omnidirectional camera may be referred to as, for example, a 360-degree panoramic image.

In the example of FIG. 11A, no icon is displayed on the first display area B1 that displays the 1b-th image C1b based on the A-th content.

Further, in the present example, the B-th content displayed on the second display area B2 of the sharing destination is the content of the map information.

In the example of FIG. 11B, a 2b-th icon 412b is displayed on the second display area B2 that displays the 2b -th image C2b based on the B-th content.

Although an aspect in which the position indicated by the 2b-th icon 412b in the 2b-th image C2b, which is the map information, and the reference position of the 1b-th image C1b, which is scenery information, match each other is shown in the present example, other aspects may be used.

Here, also in the examples of FIGS. 11A and 11B, for example, similarly to the examples of FIGS. 9A, 9B, 10A, and 10B, the first image processor 116 of the first display device A1 performs the image processing so that the coordinate movement of the 2b-th image C2b displayed on the second display area B2 of the sharing destination is performed in synchronization with the coordinate movement of the 1b-th image C1b displayed on the first display area B1 of the sharing source.

Although the coordinate movement with the swipe operation is exemplified in the present example, the screens of the sharing source and the sharing destination may be linked with respect to an image reduction with a pinch-in operation, an image enlargement with a pinch-out operation, and so on, as another example.

Note that the content displayed on the device of the sharing source and the content displayed on the device of the sharing destination may be reversed.

Here, in the 1b-th image C1b displayed on the first display area B1 of the sharing source, when the direction of the line of sight for viewing the scenery changes in a range of 360 degrees, for example, the display orientation of the 2b-th image C2b displayed on the second display area B2 of the sharing destination may not be changed or may be changed.

The display orientation is, for example, the orientation of north, south, east, or west on the map.

Here, in the present embodiment, when the first master image G1 is changed by changing the request information transmitted by the first display device A1 to the server device D1 taking the occurrence of a predetermined event in the first display device A1 as a trigger is described. That event is, for example, that the first user E1 performs a predetermined operation such as scrolling on the first display device A1 or that a predetermined automatic operation such as scrolling occurs in the first display device A1.

As another example, taking the occurrence of a predetermined event in the second display device A2 as a trigger, the second display device A2 may notify the first display device A1 of the occurrence of the event, and in response to this, the first display device A1 may change the request information transmitted to the server device D1 to thereby change the first master image G1. That event is, for example, that the second user E2 performs a predetermined operation such as scrolling on the second display device A2 or that a predetermined automatic operation such as scrolling occurs in the second display device A2. In this case, the notification from the second display device A2 to the first display device A1 is performed by transmitting predetermined information from the second display device A2 to the first display device A1.

Note that in the present embodiment, it is assumed when an operation such as scrolling occurs only in any one of the device of the sharing source and the device of the sharing destination. That is, in the present embodiment, it is assumed that the other of the devices cannot perform an operation such as scrolling.

However, a configuration in which an operation such as scrolling can occur in both the device of the sharing source and the device of the sharing destination may be used.

Further, in the present embodiment, when the first display device A1 shares the screen with the second display device A2, the first display device A1 generates an image suitable for the aspect ratio of the second display area B2 of the second display device A2 based on the second master image G2 and transmits the image thus generated to the second display device A2 is described.

As another example, when the first display device A1 shares the screen with the second display device A2, in some cases, the first display device A1 may transmit an image corresponding to the second master image G2 to the second display device A2, and the second display device A2 may generate an image suitable for the aspect ratio of the second display area B2 based on that image received by the second display device A2, and display the image thus generated. This generation processing includes, for example, setting of the second region H2 and trimming.

Note that the first display device A1 stores the aspect ratio of the first display area B1 in the first storage 114 or the like, and the second display device A2 stores the aspect ratio of the second display area B2 in the second storage 124 or the like.

Further, in the present embodiment, when the first display device A1 acquires the first master image G1 and the second master image G2 based on the information received from the server device D1 is described.

As another example, in some cases, with respect to one or both of the first master image G1 and the second master image G2, information serving as a source for generating the master image may be stored in a predetermined database, and the first display device A1 may acquire that master image based on that information.

As another example, in some cases, with respect to one or both of the first master image G1 and the second master image G2, the information serving as a source for generating the master image may be stored in the first storage 114 of the first display device A1, and the first display device A1 may acquire that master image based on that information.

For example, a configuration in which the first master image G1 and the second master image G2 are respectively provided from different server devices to the first display device A1 may be used.

Further, for example, a configuration in which one of the first master image G1 and the second master image G2 is provided from the server device D1 to the first display device A1 and the other is stored in the first display device A1 or a predetermined database other than the server device may be used.

Although the screen sharing in the combination of the first display device A1 and the second display device A2 is described above, similar screen sharing may be applied to a combination of the first display device A1 and the third display device A3. In this case, for example, the first display device A1 is the master device, and the third display device A3 is the slave device.

Note that in general, substantially the same operations are performed by the third display device A3 and the third user E3 instead of the second display device A2 and the second user E2. However, in the embodiment, the second display device A2 is a projector, whereas the third display device A3 is a tablet terminal, and the operations may differ with respect to such differences.

As described above, in the display method and the display system 1 according to the present embodiment, the first display device A1, which is an information processing device including the first display region, acquires the information of the A-th content, the coordinate information corresponding to the A-th content, and the information of the B-th content corresponding to that coordinate information. The first display device A1 displays an image of the first image data capable of displaying the A-th content in the first display region in accordance with the aspect ratio of the first display region. Then, the second display device A2 including the second display region is coupled to the first display device A1 to acquire the information of the B-th content, and displays the image of the second image data capable of displaying the B-th content in the second display region in accordance with the aspect ratio of the second display region.

Therefore, in the display method and the display system 1 according to the present embodiment, a plurality of contents associated with each other by the coordinate information can be displayed in accordance with the aspect ratio of each display area, and thus the display region can be effectively used.

In the display method and the display system 1 according to the present embodiment, for example, when screen sharing is performed from a mobile terminal, it is possible to provide flexibility to display content, display layout, and so on by synchronizing a plurality of contents based on the coordinate information.

For example, in the present embodiment, a plurality of contents such as a map or a document in which coordinate information is present are used, and images of the different contents synchronized based on the coordinate information are drawn at a terminal side that performs screen sharing and another video device. In the terminal of the sharing source, a virtual master layer for drawing an image of other content to be supplied to the sharing destination is prepared separately from the master layer for drawing the content displayed in that terminal.

Such a virtual master layer is adjusted to conform to the resolution or the aspect ratio of the sharing destination based on the coordinate information.

As a result, in the present embodiment, for example, it is possible to display the content different from the content of the sharing source in the sharing destination based on the coordinate information, and to realize flexible screen sharing.

Here, advantages of the screen sharing in the present embodiment will be described in comparison with a related-art example.

In the screen sharing system according to the related-art example, when screen sharing is performed on another video device such as an external display or a projector via a network using a mobile terminal, mirroring for copying display content of a display area of the mobile terminal to the other video device is generally performed.

In such mirroring, when screen sharing is performed between a mobile terminal and another video device different in aspect ratio, there is a problem that a margin in which an image is not displayed is generated on the screen, and there is a problem that an image displayed and the screen do not fit appropriately.

Further, when the screen sharing method is the mirroring, for example, there is a restriction that different contents cannot be shared between the sharing source and the sharing destination.

Further, for example, when a video is projected from a mobile terminal to a projector, it is possible to project the entire document such as a PDF file on the projector. However, in the related art, it is difficult to instruct enlargement or reduction of content such as a map or a document projected by a mobile terminal, and it is difficult to display information of different content in a sharing source and a sharing destination in synchronization with an operation of the mobile terminal.

In contrast, in the present embodiment, since the configuration in which the screen sharing is performed between the sharing source and the sharing destination by utilizing the synchronization of the coordinates is adopted, for example, it is possible to solve the margin problem which occurs when the screen mirroring is performed between a plurality of displays different in aspect ratio, and it is possible to appropriately fit each display image to each screen.

Further, in the present embodiment, for example, it is possible to display information of different contents between the sharing source and the sharing destination while using the same coordinate information between the sharing source and the sharing destination, and thus it is possible to increase flexibility of display and widen a range of the provision of the information.

In the display method according to the present embodiment, the first display device A1 performs acquiring the coordinate information, acquiring the first content corresponding to the coordinate information, and acquiring the second content corresponding to the coordinate information.

In the display method according to the present embodiment, displaying, on the first display area B1, the first image C1 generated based on the first aspect ratio of the first display area B1 of the first display device A1 and the first content is performed.

Further, in the display method according to the present embodiment, displaying, on the second display area B2, the second image C2 generated based on the second aspect ratio of the second display area B2 of the second display device A2 and the second content is performed.

Therefore, in the display method according to the present embodiment, for example, a plurality of contents associated by the coordinate information can be displayed in accordance with the aspect ratio of each display area, and the display region of each display area can be effectively utilized.

Here, in the present embodiment, the A-th content is an example of the first content, and the B-th content is an example of the second content.

Note that, here, when the device of the sharing source is the first display device A1 and the device of the sharing destination is the second display device A2 is described as an example, but, for example, even when the device of the sharing destination is the third display device A3, substantially the same effect can be obtained except for a difference that the second display device A2 is a projector while the third display device A3 is a tablet terminal.

In the display method according to the present embodiment, receiving, by the first display device A1, a first operation of updating the first image C1 is performed.

Further, in the display method according to the present embodiment, updating the second image C2 based on the first operation and the coordinate information is performed.

Therefore, in the display method according to the present embodiment, for example, when the first user E1 operates the first display device A1, it is possible to realize screen linkage with the second display device A2.

Note that such a configuration may not be used.

In the display method according to the present embodiment, the first operation includes at least one of a swipe operation, a pinch-in operation, a pinch-out operation, and a rotation operation.

Therefore, in the display method according to the present embodiment, when a map or the like is displayed on the first display area B1, the first user E1 can perform an intuitive operation.

Here, these operations may be performed, for example, when the first display area B1 is formed of a touch panel.

Note that such a configuration may not be used.

In the display method according to the present embodiment, information representing at least a part of the coordinate information is displayed on the first display area B1 or the second display area B2.

Therefore, in the display method according to the present embodiment, since the information indicating the positional relationship between the first image C1 and the second image C2 is displayed, for example, when the viewer compares the first image C1 and the second image C2, it is possible to make it easy for the viewer to figure out the correspondence relationship therebetween.

Here, in the present embodiment, an icon indicating a predetermined position is shown as an example of the information representing at least a part of the coordinate information, but other information may be used.

Further, the information representing at least a part of the coordinate information may be displayed on both the first display area B1 and the second display area B2, or may be displayed on any one of the first display area B1 and the second display area B2.

Note that such a configuration may not be used.

The display system 1 according to the present embodiment can implement processing corresponding to various configurations of the display method according to the present embodiment.

As a configuration example, the display system 1 according to the present embodiment includes the first display device A1 and the second display device A2.

The first display device A1 acquires the coordinate information, acquires the first content corresponding to the coordinate information, acquires the second content corresponding to the coordinate information, and displays, on the first display area B1, the first image C1 generated based on the first aspect ratio of the first display area B1 of the first display device A1 and the first content.

The first display device A1 or the second display device A2 displays, on the second display area B2, the second image C2 generated based on the second aspect ratio of the second display area B2 of the second display device A2 and the second content.

Therefore, in the display system 1 according to the present embodiment, for example, a plurality of contents associated by the coordinate information can be displayed in accordance with the aspect ratio of each display area, and the display region of each display area can be effectively utilized.

Here, the processing of displaying the second image C2 on the second display area B2 based on the second aspect ratio of the second display area B2 and the second content may be performed by, for example, the first display device A1, or may be performed by the second display device A2.

It is possible to record a program for implementing the function of any element in any apparatus described hereinabove on a computer-readable recording medium, and make a computer system read and then execute the program. The “computer system” mentioned here includes an operating system or hardware such as peripheral equipment. The “computer-readable recording medium” is a portable medium such as a flexible disk, a magneto-optical disk, a read only memory (ROM), or a compact disc (CD)-ROM, or a storage device such as a hard disk incorporated in the computer system. Further, the “computer-readable recording medium” includes what retains a program for a certain period of time such as a volatile memory located inside the computer system serving as a server or a client when the program is transmitted via a network such as the Internet or a communication line such as a telephone line. The volatile memory may be a RAM. The recording medium may be a non-transitory recording medium.

The program described above may be transmitted from a computer system in which the program is stored in a storage device or the like to another computer system via a transmission medium or by a transmission wave in the transmission medium. The “transmission medium” for transmitting the program refers to a medium including a function of transmitting information like a network such as the Internet or a communication line such as a telephone line.

The program described above may be a program for implementing a part of the functions described above. The program described above may be a so-called differential file that can achieve the function described above in combination with a program already recorded on the computer system. The differential file may be referred to as a differential program.

The function of any element in any apparatus described hereinabove may be implemented by a processor. Each processing in the embodiment may be implemented by a processor that operates based on the information such as a program and a computer-readable recording medium that stores the information such as a program. In the processor, the function of each unit may be implemented by individual hardware, or the function of each unit may be implemented by integrated hardware. The processor may include hardware, and the hardware may include at least one of a circuit that processes a digital signal and a circuit that processes an analog signal. The processor may be implemented using one or both of a single circuit device or a plurality of circuit devices mounted on a circuit board, and a single circuit element or a plurality of circuit elements. An integrated circuit (IC) or the like may be used as the circuit device, and a resistor, a capacitor, and so on may be used as the circuit element.

The processor may be a CPU. However, the processor is not limited to the CPU, and various processors such as a graphics processing unit (GPU) or a digital signal processor (DSP) may be used. The processor may be a hardware circuit using an application specific integrated circuit (ASIC). The processor may include a plurality of CPUs, or may include a hardware circuit including a plurality of ASICs. The processor may be implemented by a combination of a plurality of CPUs and a hardware circuit including a plurality of ASICs. The processor may include one or more of an amplifier circuit, a filter circuit, or the like that processes an analog signal.

While the embodiment is hereinabove described in detail with reference to the drawings, the specific configurations are not limited to the embodiment, and include designs and the like without departing from the scope of the present disclosure.

### SUMMARY OF PRESENT DISCLOSURE

A summary of the present disclosure will be appended below.

### Appendix 1

A display method including
acquiring, by a first display device, coordinate information;
acquiring, by the first display device, first content corresponding to the coordinate information;
acquiring, by the first display device, second content corresponding to the coordinate information;
displaying, on a first display area, the first display area being an area in which a first image is displayed by the first display device, the first image generated based on a first aspect ratio of the first display area and the first content; and
displaying, on a second display area, the second display area being an area in which a second image is displayed by a second display device, the second image generated based on a second aspect ratio of the second display area and the second content.

Accordingly, for example, a plurality of contents associated with each other by the coordinate information can be displayed in accordance with the aspect ratio of each display area, and the display region of each display area can be effectively used.

### Appendix 2

The display method according to Appendix 1, wherein
the first display device
receives a first operation for updating the first image, and
updates the second image based on the first operation and the coordinate information.

Accordingly, for example, when the user operates the first display device, it is possible to realize screen linkage with the second display device.

### Appendix 3

The display method according to Appendix 2, wherein
the first operation includes at least one of a swipe operation, a pinch-in operation, a pinch-out operation, and a rotation operation.

Accordingly, when a map or the like is displayed on the first display area, the user can perform an intuitive operation.

### Appendix 4

The display method according to any one of Appendices 1 to 3, further including
displaying information representing at least a part of the coordinate information on the first display area or the second display area.

Thus, since the information representing the positional relationship between the first image and the second image is displayed, for example, when the viewer compares the first image and the second image with each other, the viewer can easily figure out the correspondence relationship therebetween.

### Appendix 5

A display system including
a first display device; and
a second display device, wherein
the first display device
acquires coordinate information,
acquires first content corresponding to the coordinate information,
acquires second content corresponding to the coordinate information, and
displays, on a first display area, the first display area being an area in which a first image is displayed by the first display device, the first image generated based on a first aspect ratio of the first display area and the first content, and
the first display device or the second display device displays, on a second display area, the second display area being an area in which a second image is displayed by the second display device, the second image generated based on a second aspect ratio of the second display area and the second content.

Accordingly, for example, a plurality of contents associated with each other by the coordinate information can be displayed in accordance with the aspect ratio of each display area, and the display region of each display area can be effectively used.

What is claimed is:

1. A display method comprising:
acquiring, by a first display device, first content and coordinate information corresponding to the first content;
acquiring, by the first display device, second content corresponding to the coordinate information;
displaying, on a first display area, the first display area being an area in which a first image is displayed by the first display device, the first image generated based on a first aspect ratio of the first display area and the first content; and
displaying, on a second display area, the second display area being an area in which a second image is displayed by a second display device, the second image generated based on a second aspect ratio of the second display area and the second content.

2. The display method according to claim 1, wherein
the first display device
receives a first operation for updating the first image, and
updates the second image based on the first operation and the coordinate information.

3. The display method according to claim 2, wherein
the first operation includes at least one of a swipe operation, a pinch-in operation, a pinch-out operation, and a rotation operation.

4. The display method according to claim 1, further comprising:
displaying information representing at least a part of the coordinate information on the first display area or the second display area.

5. A display system comprising:
a first display device; and
a second display device, wherein
the first display device
acquires first content,
acquires coordinate information corresponding to the first content,
acquires second content corresponding to the coordinate information, and
displays, on a first display area, the first display area being an area in which a first image is displayed by the first display device, the first image generated based on a first aspect ratio of the first display area and the first content, and
the first display device or the second display device displays, on a second display area, the second display area being an area in which a second image is displayed by the second display device, the second image generated based on a second aspect ratio of the second display area and the second content.
